(19) United States
(12) Patent Application Publication
(10) Pub. No.: US 2019/0393756 A1
(43) Pub. Date: Dec. 26, 2019

(54) SYSTEM AND METHOD FOR GRAVITY BASED POWER GENERATION

(71) Applicant: Jody Nehmeh, PHOENIX, AZ (US)

(72) Inventor: Jody Nehmeh, PHOENIX, AZ (US)

(21) Appl. No.: 16/563,706

(22) Filed: Sep. 6, 2019

Related U.S. Application Data
(63) Continuation-in-part of application No. 15/433,989, filed on Feb. 15, 2017.
Application No. 15/433,989 is a continuation-in-part of application No. 14/675,583, filed on Mar. 31, 2015, now Pat. No. 10,197,602.
Application No. 14/675,583 is a continuation-in-part of application No. 13/724,311, filed on Dec. 21, 2012, now Pat. No. 9,612,262.
(60) Provisional application No. 62/728,635, filed on Sep. 7, 2018.
(60) Provisional application No. 62/295,463, filed on Feb. 15, 2016.
(60) Provisional application No. 61/973,093, filed on Mar. 31, 2014.

(51) Int. Cl. H02K 7/18; F03G 3/00; H02K 7/10

(52) U.S. Cl. CPC H02K 7/1853; H02K 7/1004; F03G 3/00

(57) ABSTRACT

A power generation system that relies on gravity. The system provides uninterrupted electrical power without dependency on the grid making electrical power generation autonomous if needed or working along with other power systems such as the grid to provide primary or backup power as required by the user.

### CROSS-REFERENCE TO RELATED APPLICATIONS

This application claims the benefit of U.S. Provisional Patent Application No. 62/728,653 filed Sep. 7, 2018, the contents of which are hereby incorporated by reference. This application is also a continuation of U.S. patent application Ser. No. 15/433,989, filed Feb. 15, 2017 which in turn claims the benefit of U.S. Provisional Patent Application No. 62/295,463 filed Feb. 15, 2016 and is also a continuation in part of U.S. patent application Ser. No. 14/675,583, filed Mar. 31, 2015, the disclosure of which is incorporated herein by reference. U.S. patent application Ser. No. 14/675,583 is a continuation in part of Ser. No. 13/724,311 filed Dec. 21, 2012, and also claims benefit of U.S. Provisional Patent Application No. 61/973,093 filed Mar. 31, 2014, the contents of which are hereby incorporated by reference.

### TECHNICAL FIELD

This description relates generally to power generation and more specifically to electrical power generation.

### BACKGROUND

Alternative energy sources are available today in the form of solar, wind and hydroelectric technologies. Each of these resources has limitations in terms of power generation. Solar cannot generate power when sun rays are weak or not available. Similarly, wind energy cannot be generated without wind. In either case, the electric grid or batteries is needed to supplement power generation when wind or solar energies are not available.

Hydroelectric energy is also limited to the availability of flowing water and perhaps large-scale power generation which requires the presence of the grid to provide power to users.

On the other hand, gravity is available everywhere on the planet. Accordingly, it would be desirable to utilize gravity in the generation and storage of energy.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a power generation system that relies on gravity. The system provides uninterrupted electrical power without dependency on the grid making electrical power generation autonomous if needed or working along with other power systems such as the grid to provide primary or backup power as required by the user.

Weights are raised and lowered to turn a generator shaft and generate electricity. The system includes a controller and a clutch mechanism to engage and disengage the weights.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows the drop system pulley configuration.

FIG. 2 shows the generator attachment to the pulley system.

FIG. 3 shows the integrated drop/lift mechanisms.

FIG. 4 shows the drop system in operation.

FIG. 5 shows the lift system in operation.

FIG. 6 shows multiple drop/lift mechanisms driving a power generation system.

Like reference numerals are used to designate like parts in the accompanying drawings.

### DETAILED DESCRIPTION

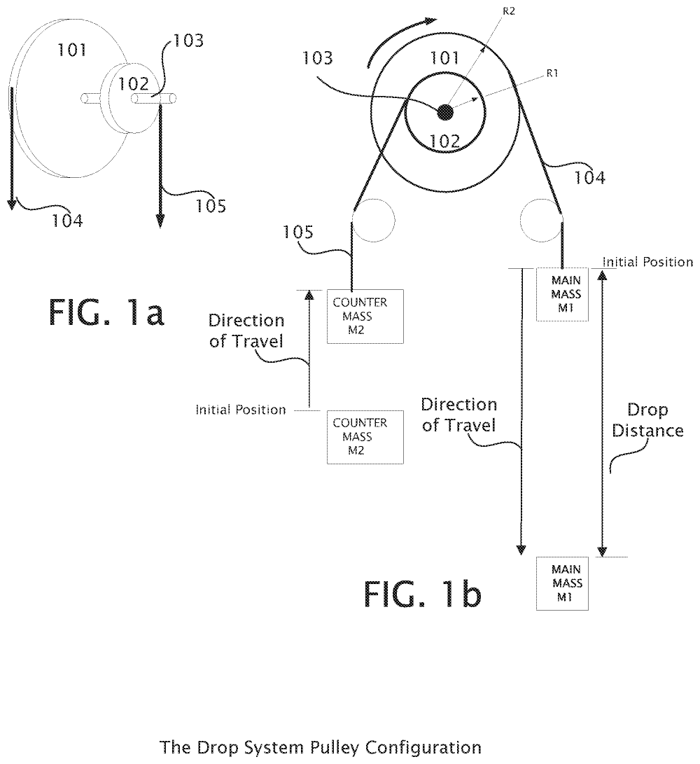

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples. Understanding of the following description will be facilitated by referring to any of FIGS. 1-6.

Introduction

This patent application describes a Gravity based Electrical Power Generation System. This system can be used to provide electrical power to homes or other applications as an alternative source of power that is independent of the electrical grid extracting power from gravity.

The system described herein is scalable and can provide larger or smaller amounts of electrical power as required by the user. The system can operate autonomously and does not require any assistance from solar panels, wind energy, or the grid, but can be used in conjunction with these systems to generate power.

The system utilizes batteries to store electrical energy to maintain a steady average output and to provide power on a temporary basis to prevent disruption of power during failures.

The system contains the capability to monitor itself and provide usage and diagnostics information to the user or the electrical service provider for continuous external user monitoring and control. This information is provided through hardwired or wireless interfaces.

Like solar and wind turbine systems, this system can provide excess power to the grid and provides the user with measurements of the amount of power provided to the grid.

Theory of Operation

The main concept for the generation of energy is to drop a mass from a certain height to generate kinetic energy, then lift this mass back up to it original position without expending the same amount of energy. The difference between the mechanical energy collected from dropping the mass to that expended by lifting the mass back it its original position is converted to electrical energy through an electric generator.

The following explains how the system works to generate power.

The first step in the power generation sequence is to drop a mass from a certain height to generate kinetic energy.

The kinetic energy generated by the drop is captured and converted to the desired form of power. In this case electrical, but it can in the form of other combinations such as electrical and mechanical as called for by the application.

The dropped mass reaches the bottom of travel and stops. Then the mass is lifted back up to its original position by another mechanical system that is designed to perform this lift for a fraction of the energy generated through the drop process.

During the lifting process of the dropped mass, other redundant systems will be dropping other masses to maintain sustained power generation. These other masses will also be lifted back to their original position once they reach their bottom of travel.

Once a mass is lifted up to its original position, the mass is ready to be dropped again when needed to sustain continuous power generation.

The combined generated power from the system is converted from mechanical power generated by the drop to electrical energy and captured in storage devices such as batteries, capacitors or the like.

The stored power is then converted to the form of power required by the user: AC or DC, or other forms of mechanical power.

Power Capture and Generation (Mass Drop Phase)

Refer to FIG. 1 for the drop phase implementation. Two pullies 101,102 of different sizes are attached to a single shaft 103 as shown in FIG. 1 (a). A Main Mass (M1) is attached to the larger pulley through a cable 104 that is wrapped around the pulley and placed at the top as shown in FIG. 1 (b). A second equal mass M2 is attached to the smaller pulley through a second cable as shown in FIG. 1 (b). M1 is placed and held at the top of travel, while M2 cable is fully extended with M2 hanging at the bottom of its travel. M2 cable is designed to wrap around the smaller pulley as M1 travels downward.

When M1 is released, M1 will accelerate in the down direction at a constant acceleration while M2 travels upwards. This occurs due to the difference in torque generated by each pulley. The cable attaching masses M1, and M2 to the pullies are designed such that when M1 reaches the end of its travel at the bottom, M2 reaches its top of travel. Due to the difference in pulley sizes, M2 travel is shorter than M1 travel.

The shaft 103 of this pulley system is coupled to an electric generator (not shown). As M1 accelerates downward the pulley system shaft 103 turns causing the generator to turn thus converting the kinetic energy generated by dropping M1 to electrical energy. When the mass reaches the bottom, the mass impacts mechanical stops (not shown) that are designed to capture the impact energy. Once the mass M1 drop is completed, the mass M1 will be lifted back to its original position as described in the following section.

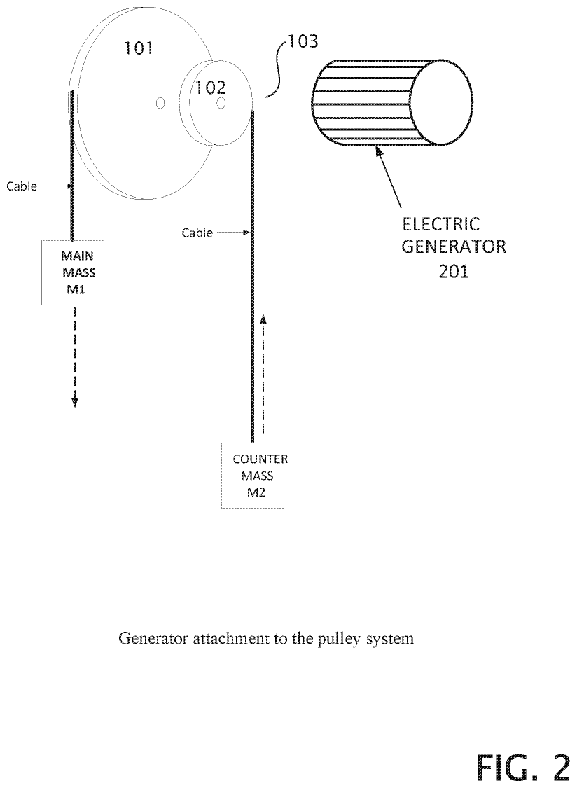

FIG. 2 shows the generator 201 attachment to the pulley system. As the mass is being lifted, other redundant drop mechanisms, as further described below may be utilized such that there is typically always a mass being dropped at any point in time (for the purpose of sustained power generation). FIG. 2 shows how a generator 201 is attached to the pulley system 101, 102,103.

Mass Lift Mechanisms (Mass Lift Phase)

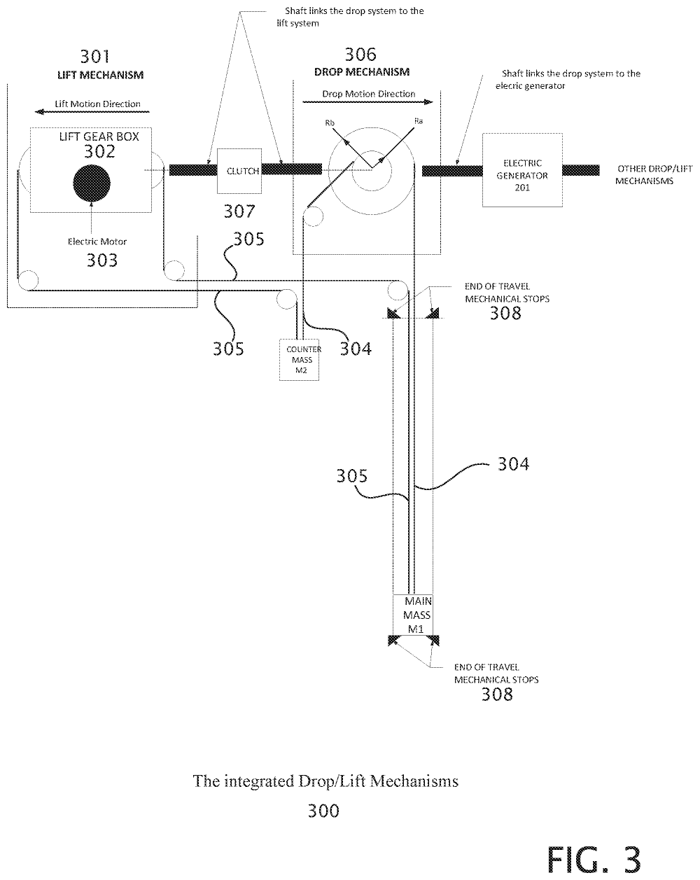

FIG. 3 shows the integrated drop/lift mechanisms 300. For continuous generation of power, it may be necessary to continue the drop cycle by returning the M1 masses up to its original position. The energy consumed to lift the mass M1 up to its original position is configured to be a fraction of that generated by dropping M1, otherwise, all the generated power will be consumed in the effort to return M1 to its initial position.

To accomplish this, another independent mechanism 301 is used to lift M1. This mechanism 301 is designed to switch the mechanical weight advantage from M1 to M2 while retaining the same travel ratios between the two masses. This mechanism 301 utilizes a specially designed gearbox 302 and is assisted by an electric motor 303 to facilitate lift. In other words, M2 would travel from it up position downward to its initial start position causing M1 to travel the full distance to its up position. In order to retain a positive balance of energy, the energy used to lift M1 to its initial position has to such that the sum of forces on the system during the lift phase are close to equilibrium. Then movement of the Masses: M2 down and M1 up is controlled by the electric motor 303 that is coupled to this gearbox mechanism and does not require a great deal of energy due to the equilibrium state experienced by the lift gearbox 302.

During the lift motion, the drop mechanism pullies rotate in a direction opposite to the motion of the Drop phase.

Further referring to FIG. 3 for the integrated drop/lift system:

2 cables are attached to each mass: one cable system 304 shown in FIG. 3 is typically only used during drop, and the other cable system 305 shown in FIG. 3 is typically only used during Lift.

During the Drop phase, the Lift Gear Box 302 shown on the left of FIG. 3 is designed to idle during the drop state and is not linked to the drop mechanism 306 shown to its right.

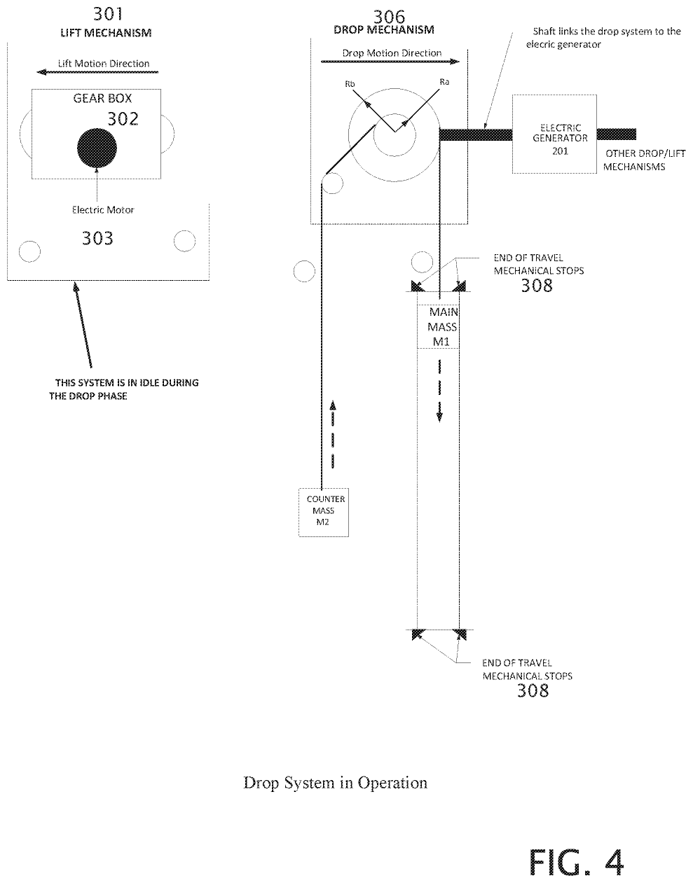

FIG. 4 shows the drop system in operation. FIG. 4 shows effectively what happens to this gearbox 302 during the drop phase. The lift system is declutched and becomes completely idle.

When M1 impacts the mechanical stops 304 at the end of travel, the lift system 301 is engaged, and the electric motor 303 is used to rotate the gearbox 302 in a direction opposite to the drop direction with the mechanical advantage favoring M2 over M1.

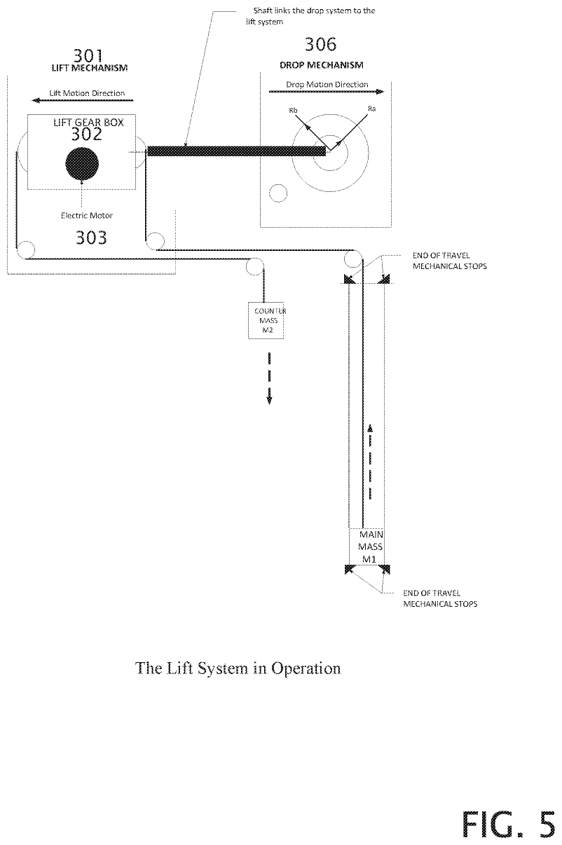

FIG. 5 shows the lift system in operation. FIG. 5 shows the lift cables only as they are the ones performing the lift operation. The drop cables are ineffective during this phase. During lift, the generator (not shown in FIG. 5) is disengaged from the system.

When M1 reaches the top, the lift system 301 is disengaged, and the drop system 306 is engaged when commanded causing M1 to accelerate again towards the bottom.

At some point during the drop, when M1 speed is adequate, the generator 201 is engaged

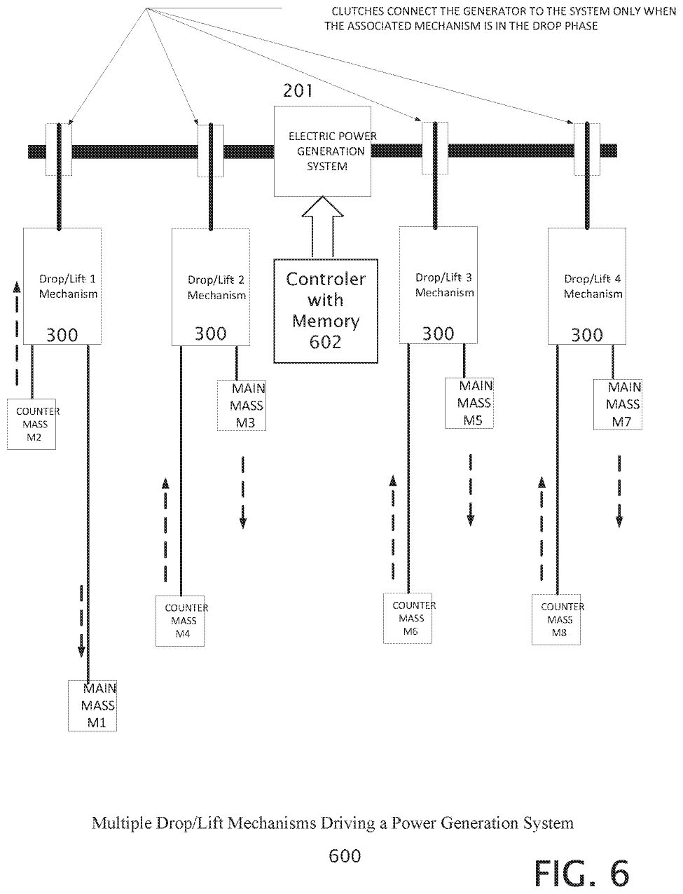

FIG. 6 shows multiple drop/lift mechanisms driving a power generation system 600. For continuous power generation, during lift, other similar drop/lift mechanisms 300 are synchronized to perform mass drops for sustained electrical power generation in the generator 201. This example shows 4 drop units, the number of drop units is variable depending on the application and the drop distance.

Power generation management is performed by a computer system 602 that monitors the activities of the system, power demand and based on the inputs, initiates a sequence of drops for sustained power output. When M1 is close to reaching the bottom, M3 is released, and M1 Lift mechanism is engaged. As M3 accelerates towards the bottom, M1 is being lifted. Soon as M3 is close to reaching the bottom, M5 is released, and M1 is close to reaching its top position. This sequence continues in a round robin configuration.

Electrical Power Generation

The electrical power generation system consists of one or multiple generators depending on the application. The drop mechanical energy is converted to electrical power through the electric generator system, rectified and stored in capacitors or batteries. The stored energy is converted into AC and passed to the user. The output of the generator(s) is converted to the appropriate voltage levels (AC or DC) as required by the user. The system computes the amount of energy stored in the system and manages how to pass this energy from the drop mechanisms to the generator in such a way that does not cause the generator output to drop beyond a certain voltage. Excess power is stored in Batteries to allow the system to operate for a predetermined period without the operation of the generators to limit down time in case of failures. Part of this stored power is wrapped around to the lift system to power the lift system electric motors.

Those skilled in the art will realize that the process sequences described above may be equivalently performed in any order to achieve a desired result. Also, sub-processes may typically be omitted as desired without taking away from the overall functionality of the processes described above.

Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A method of storing power comprising:
raising a weight to a desired height with a pulley attached to a shaft to store an amount of energy expended in raising the weight:
releasing the weight to drive a generator coupled to the shaft: and
generating electrical power from the generator.
